(19) United States
(12) Patent Application Publication
(10) Pub. No.: US 2024/0211628 A1
(43) Pub. Date: Jun. 27, 2024

(54) PROXIMITY AND INTENT CENTRIC PERSONAL DATA SHARING SYSTEM

(71) Applicant: CERGE PTY LTD., Peregian Beach, Queensland (AU)

(72) Inventors: Christopher KERRISK, Buderim, Queensland (AU); Victoria KERRISK, Buderim, Queensland (AU)

(21) Appl. No.: 18/555,357

(22) PCT Filed: Apr. 12, 2022
(86) PCT No.: PCT/AU2022/050326

§ 371 Date: Oct. 13, 2023

(30) Foreign Application Priority Data
Apr. 13, 2021 (AU) 2021901068

(51) Int. Cl. G06F 21/62; G06F 9/54; G06Q 30/0207

(52) U.S. Cl. CPC G06F 21/6245; G06F 9/544; G06Q 30/0236

(57) ABSTRACT

One aspect of the invention disclosed relates to a personal data sharing system (which may be a proximity and intent centric personal data sharing system) comprising: an application program interface (API) that interacts with a database storing system settings and system data; a user application associated with a user device for entry of user data and transfer of the user data to and from the API (and database); and a provider interface associated with a provider device for entry of provider data and transfer of the provider data to and from the API (and database). A user of the personal data sharing system can, via the user application, notify a provider of an intent to arrive at a location of that provider, and when the user arrives at, or is within a predetermined distance of, the provider location, an alert is provided to the provider (or to personnel at the provider location via the provider interface).

### FIELD OF THE INVENTION

The present invention relates to a personal data sharing system, which may take the form of a proximity and intent centric personal data sharing system, for example, for use in retail, hospitality, leisure, accommodation, medical, allied health, hairdressers, clubs and other similar environments where personal and/or service interactions occur. The invention involves sharing of data, for example, when a user has a pre-determined intent to visit such a venue and possibly interact with service personnel at the venue.

### BACKGROUND

In retail stores and the like, most retailers don't know if a customer entering the premises is an existing customer and they generally are not aware of what (or even if) the customer is intent on purchasing.

From a retailer's perspective, customers who have had good past experiences in a store will generally spend more than those who have had poorer past experiences. Many retailers work towards building experiences and services that customers would be willing to pay for, and which will (or may) consequently increase revenue. It is believed that improved customer experience can therefore create (or lead to) a commercial advantage in many settings. It is therefore thought that it may be advantageous for retailers to be aware of details of customers who are entering their store, for example, who the customer is, their name, when they last visited the store, any specific needs the customer may have, their intent to purchase, what they may have purchased recently, if anything, etc.

From a consumer's perspective, sharing of personal data can often be a concern. Many consumers may be willing to share personal data if there is some form of reward or benefit for doing so. Indeed, many may be happy to share e.g. a facial picture and name with a brick-and-mortar retailer if they are in control of the data exchange. However, consumers may be less comfortable with the use of e.g. facial recognition technologies. Many may be happy to share personal information, such as name, clothing size and preferences, and the like, in return for e.g. personalised customer service, priority service, skipping the queue, exclusive offers, etc. It is thought that the new generation of consumer may be moving from one that is primarily concerned with price, to one that is searching for personalised customer service, including possibly based on their data, or perhaps one that desires privileges and perks that money can't buy, possibly in exchange for handing over personal information. It is therefore thought that it may be advantageous if a system could be provided that facilitates improved customer experiences in stores and other environments where customers receive personal service, and/or that provides rewards, based on personal data exchanged with (and with the consent of) the customer.

Significantly, the greatest form of discrimination faced by customers with disability is from service and hospitality staff. In most instances, this discrimination is a result of a lack of awareness and understanding by staff of a customer's needs. Over 71% of disabilities are invisible, and many forms of disability are unique, making it difficult or impossible to train and educate staff to adequately service all customers. It is therefore thought that it may be advantageous if a system could be provided that facilitates personalised customer service where certain personal information of the customer is shared before a customer visits, or as the customer approaches or arrives at, e.g. a retailer or other location where a personal services interaction may be involved. This may help to remove (or reduce) the fear and anxiety often experienced by customers with disability before and during a customer service experience, and/or it may enable the customer service staff to provide a customer with the service(s) they require, and/or in a way that is effective and desirable for the customer.

The subject matter claimed herein is not limited to embodiments that solve or address any particular problems or issues or that operate only in environments such as those described above. Rather, the background information above is provided simply to illustrate, by way of example, areas where (or ways in which) some embodiments described herein may be practiced.

It is also to be clearly understood that mere reference herein to any previous or existing products, systems, methods, practices, publications, patents, or indeed to any other information, or to any problems or issues, does not constitute an acknowledgement or admission that any of those things, whether individually or in any combination, formed part of the common general knowledge of those skilled in the field or is admissible prior art.

### SUMMARY OF THE INVENTION

As mentioned above, the present invention relates to a personal data sharing system, which may take the form of a proximity and intent centric personal data sharing system, for example, for use in retail, hospitality, leisure, accommodation, medical, allied health, hairdressers, clubs and other similar environments where personal and/or service interactions occur. The invention involves sharing of data, for example, when a user has a pre-determined intent to visit such a venue and possibly interact with service personnel at the venue.

According to one aspect of the invention (albeit not necessarily the only or broadest aspect) there is provided a personal data sharing system (which may be a proximity and intent centric personal data sharing system) comprising:
an application program interface (API) that interacts with (i.e. saves data to and retrieves data from) a database storing system settings and system data;
a user application associated with a user device for entry of user data and transfer of the user data to and from the API (and database); and
a provider interface associated with a provider device for entry of provider data and transfer of the provider data to and from the API (and database),
wherein a user of the personal data sharing system can, via the user application, notify a provider of an intent to arrive at a location of that provider, and when the user arrives at (or is within a predetermined distance of) the provider location, an alert is provided to the provider (or to personnel at the provider location via the provider interface).

To notify the provider of the user's intent to arrive at the provider location, the user may be able to, via the user application, send a user intention notification which may be received via the provider interface. The user intention notification may contain information which the user has previously (typically prior to the sending of the user intention notification) entered via the user application and which personnel at the provider location may use to help provide the user with service(s) sought by the user and/or in a way that is effective and desirable for the user.

In some embodiments, a user may be prevented from notifying a provider of their intent to arrive at a provider location of that provider (i.e. prevented from sending a user intention notification) when the user is already at, or within the predetermined distance of, that provider location. This may help prevent an intention notification for a particular user being sent too soon before (i.e. to close to the time when) the user arrives, or as they arrive, or after they have already arrived, at the relevant provider location.

When a user intention notification is received via the provider interface of a provider, but before the user arrives at, or is within a predetermined distance of, the relevant provider location, the provider interface may produce a visible and/or audible alert to inform personnel at the relevant provider location of the user's intended arrival. The information which the user enters via the user application (some or all of which may be provided to the provider interface in (or as part of) the user intention notification) may include the user's estimated time of arrival at the provider location, and optionally also other information including “must know” information (being information the user wishes personnel at the relevant provider location to know) and/or “purpose” information (being information about, or related to, the user's reasons for visiting the particular provider location).

Personnel (e.g. service staff) at the provider location may be able to, via the provider interface, select to either acknowledge or ignore a user intention notification. If personnel at the provider location select, via the provider interface, to acknowledge the user intention notification, an acknowledgement notification may be returned and received by the user via the user application. On the other hand, if personnel at the provider location select, via the provider interface, to ignore the user intention notification, it may be that no notification is returned.

When a user arrives at, or is within a predetermined distance of, a provider location which the user intends to visit, the user may be able to, via the user application, “check-in” to (and thereby confirm their arrival at) that provider location. The user application may be configured to perform “check-in” automatically when the user arrives at, or is within the predetermined distance of, the relevant provider location. The user application may alternatively be, or it may also be (at the user's election), configured such that “check-in” must be performed manually by the user via the user application upon arrival at, or when the user is within the predetermined distance of, the relevant provider location. In any case, when a user, via the user application (whether automatically or manually) “checks-in” to (and thereby confirms their arrival at) the relevant provider location, an arrival alert may be generated by the provider interface.

When an arrival alert is generated by the provider interface (caused by a user “checking-in” to the relevant provider location), information including “must know” information (being information the user wishes personnel at the relevant provider location to know) and/or “purpose” information (being information about, or related to, the user's reasons for visiting the particular provider location) may be made available to personnel at the provider location via the provider interface.

The arrival alert generated by the provider interface (this occurs when a user “checks-in” to (and thereby confirms their arrival at) the relevant provider location, as discussed above) may include a visible and/or audible alert to inform personnel at the provider location of the user's arrival.

In general, a user should preferably be able to, via the user application, enter and/or manage and/or control and/or change information that is shared with providers (such as e.g. personal data and/or preferences). Also, the system should be such that a user can, via the user application, control and/or manage and/or change which providers any of their information can be shared with.

In some embodiments, the user application may be able to receive invitations from one or more providers, and the user may be able to, via the user application, select an invitation from a particular provider to obtain information about that provider. The invitations received by the user application for a particular user (i.e. what invitations are received, from which providers) may be determined (e.g. filtered or otherwise determined) based on information that the user has entered via the user application. This may change from time to time if the user changes the information supplied to the user application, or makes changes to what information is shared, or to which providers (or kinds of providers), etc. In any case, the information about a provider that the user can obtain by selecting the invitation from that provider will generally include, at least, the distance to the provider's closest location and the address of that closest provider location. A range of additional information about the provider, or the provider's closest location, may also be obtainable by the user by selecting the invitation from that provider.

A user may be able to, via the user application, accept an invitation from one or more providers, and a provider for which the invitation is accepted by the user may be caused to be saved as part of the user's preference data in the database.

In general, the provider interface may be used to enable a provider to do any one or more of the following: setup their system profile(s), enter and/or manage their provider location(s), enter and/or manage any specific offers or incentives being offered, enter and/or manage their accessibility features, enter and/or manage details and information which may be necessary or helpful to enable a user to share data with them and/or which may help to attract existing user customers, new user customers and/or user customers with disability or other specific needs, and/or allow such user customers to express their interest.

The personal data sharing system may also provide a functionality whereby a first (dependent) user of the system can, via the user application on the device of that user, authorise and enable a second (controlling) user to control and operate functions of the user application on behalf of the first (dependent) user. This functionality may find use, for example, where a first (dependent) user suffers from a disability that impedes or prevents their ability to use the user application on their own behalf (at least in certain circumstances), such that it is desirable to allow a second (controlling) user to control and operate the functions of the user application on their behalf. This functionality may also find use in other situations and scenarios.

In embodiments having the functionality described in the previous paragraph, a second (controlling) user who is authorised and enabled to control and operate functions of the user application on behalf of a first (dependent) user may be able to control and operate the functions of the user application on behalf of that first (dependent) user using (i.e. from) the second (controlling) user's device. However, in order to ensure that the first (dependent) user remains involved and informed about interactions that are made through or via the system related to them or on their behalf, it will preferably be the case that where a second (controlling) user is authorised and enabled to control and operate functions of the user application on behalf of a first (dependent) user, notifications and information that would appear on a user's device as a result of information entered, or notifications sent, by that user (i.e. if that user did so on their own behalf, on their own device), will also appear on the device of the first (dependent) user even though (or even if) information may have been entered, or notifications sent, on behalf of the first (dependent) user by the second (controlling) user and using the second (controlling) user's device.

Also, it will preferably be the case that, where a second (controlling) user is authorised and enabled to control and operate functions of the user application on behalf of a first (dependent) user, to notify a provider of the first (dependent) user's intent to arrive at a provider location of that provider, the second (controlling) user can, via the user application on the second (controlling) user's device, send a user intention notification to the provider on behalf of the first (dependent) user which is received via the provider interface, and once the user intention notification has been sent, the user application on the first (dependent) user's device is activated and begins to attempt to automatically check-in at the provider location such that if the first (dependent) user arrives at, or comes within the predetermined distance of, the relevant provider location alone or without the second (controlling) user, the first (dependent) user's device will perform “check-in” automatically and an arrival alert will be generated by the provider interface.

Preferably, a second (controlling) user who is authorised and enabled to control and operate functions of the user application on behalf of a first (dependent) user should not be able to authorise and enable another user to control the user application on their behalf. This is for safety and security reasons.

When a user selects a provider to share their user data with, provider locations of that provider may be displayed (or made available to) the user via the user application, and these may be stored as associated provider data. The provider may have a single location, or multiple locations, which may be entered by the provider via the provider interface and updated on a regular basis if needed. It may be that users can effectively “opt in” individually to (i.e. authorise the sharing of information individually to) each participating provider (e.g. retailer). This may help to ensure that all data transfers are permission based and under the control of the individual user (or another user authorised to act on their behalf).

Any suitable means may be used to identify whether a user is at or within the predetermined distance of a provider location. In one embodiment, identifying that a user is at or within the predetermined distance of a provider location may be achieved through a Global Positioning System (GPS) functionality of the user device. In another embodiment, identifying that a user is at or within the predetermined distance of a provider location may be achieved through a provider beacon that is activated when the user device is within the predetermined distance, for example through GPS data, Bluetooth and/or WiFi. Bluetooth and/or WiFi functionality on the user device may be activated by the user application when the user device approaches the provider location.

The alert sent to the provider when a user is within the predetermined distance of a provider location may be a simple alert that the user is approaching, although as explained above, the alert will generally also include user data. For example, the user data may include a facial photograph of the user. The user data may also include “must know” and/or “purpose” information and/or details relating to one of more of: user preferences, disability, purpose, intent, clothes size, footwear size, brand preferences, items of interest, memberships, frequent flyer memberships, emergency contact details, allergies and intolerances, last visit to store/establishment/location, previous purchases, net worth, income, and special offers made to the user.

The predetermined distance is not particularly limited and may be determined based on the circumstances. In other words, it may vary in different situations and environments. For example, in an indoor shopping centre, the predetermined distance may be relatively small, whereas in an outdoor setting it may be much larger. Generally, it is envisaged that the predetermined distance may be from about 10 m-200 m, and it is thought that a setting of about 100 m for outdoor environments, and about 20 m for indoor (e.g. shopping centre) environments, may be appropriate. However, no limitation as to be implied from this.

In certain embodiments, a user may be identified as “in store” on the provider interface/device if the user is within the predetermined distance, and a user may be identified as “out of store” if not within the predetermined distance. For example, the user may be identified as out of store when the user exits the stores and is outside the predetermined distance.

When a user is identified as “in store” on the provider device/interface, the provider may be able to acknowledge the user as “in store” (i.e. the provider may be able to acknowledge that the user has arrived) by sending a notification back to the user application of their status as “in store”, enabling two-way communication and payment requests between user application and provider device.

In certain embodiments, the user application may ping the user's current location periodically. That is, the user application, through the user device, may send a query to determine whether the user device is within the proximity of a provider location.

In certain embodiments, the user application may ping the user's current location periodically based upon the proximity of a provider location, and this may be done in combination with (and in particular the period between pings may be adjusted according to) an active notification from user to same provider. The time between pings may decrease as the proximity to an enabled provider location decreases. As an example, the user application may call the API's endpoint ping with the current user location periodically, which may be configurable (i.e. every 30 minutes). Ping endpoint can then check the user's current location against a list of accepted provider store locations and active notifications. If the closest retail store is 20 meters away the user may be marked as in that provider location and unmarked as in any other provider location. If the closest provider location is more than 20 meters away the user may be unmarked as in any provider location.

The number of minutes until the next call to ping endpoint based on the distance to the closest retail store may then be established. For example, less than or equal to 20 meters: 15 seconds, less than or equal to 250 meters and more than 20 meters: 1 minute, less than or equal to 500 meters and more than 250 meters: 3 minutes, less than or equal to 1000 meters and more than 500 meters: 5 minutes, less than or equal to 5000 meters and more than 1000 meters: 15 minutes, more than 5000 meters: 30 minutes or any combination or variation thereof. However, no limitation as to be implied from this.

The user application may further send provider details to the user. For example, returning provider and provider location information to the user if the distance is within 20 meters (configurable). The user application may provide a list of providers and provider locations, as discussed above and below.

If the user application identifies that the user is in-store at a provider location, it may check the current user location every minute, 2, 3, 4 or 5 minutes until the user leaves the provider location (e.g. distance more than 20 meters), and when the user leaves, call ping endpoint.

When a notification has been received on the provider device/interface, the provider is able to acknowledge the user notification by sending a notification back to the user application of their notification enabling two-way communication between user application and provider device.

### BRIEF DESCRIPTION OF THE ACCOMPANYING FIGURES

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description makes reference to a number of Figures as follows:

FIG. 1 schematically illustrates the system architecture used in an embodiment of a proximity and intent centric personal data sharing system.

FIGS. 2A and 2B are examples of profile setup pages of the user application.

FIGS. 3A and 3B are examples of a profile screen and a preference screen, respectively, of the user application.

FIG. 4 is an example of a shopping status screen of the user application.

FIG. 5 is an example of an invitation screen of the user application.

FIG. 6 is an example of a search/filter screen of the user application.

FIG. 7 is an example of an invitation detail screen of the user application.

FIG. 8 is an example of a loyalty screen of the user application.

FIGS. 9A and 9B are examples of accepted providers screens of the user application.

FIG. 10 is an example of a rejected providers screen of the user application.

FIGS. 11A and 11B are examples of a review screen, and a rate provider screen, respectively, of the user application.

FIG. 12 illustrates sending a notification from the user application prior to arrival at the intended establishment.

FIG. 13 is an example of an account settings page of the provider interface.

FIG. 14 is an example of a create invitation page of the provider interface.

FIG. 15 is an example of a shopper notifications page of the provider interface.

FIG. 16 is an example of a shoppers in-store page of the provider interface.

FIG. 17 is an example of a shopper history of the provider interface.

FIGS. 18-30 relate to a further functionality that the user application may (optionally) offer, namely a functionality whereby a user, such as e.g. a person who suffers from a relatively severe physical disability which impairs their ability to use (or prevents them from using) their own device (or the user application) in certain situations, may authorise and enable another (e.g. a carer) to operate and control the functions of the user application on their behalf but using (i.e. from) the carer's own (separate) device. FIGS. 18-30 also illustrates the way in which a user can authorise and enable a carer to operate and control the functions of the user application on their behalf.

### DETAILED DESCRIPTION

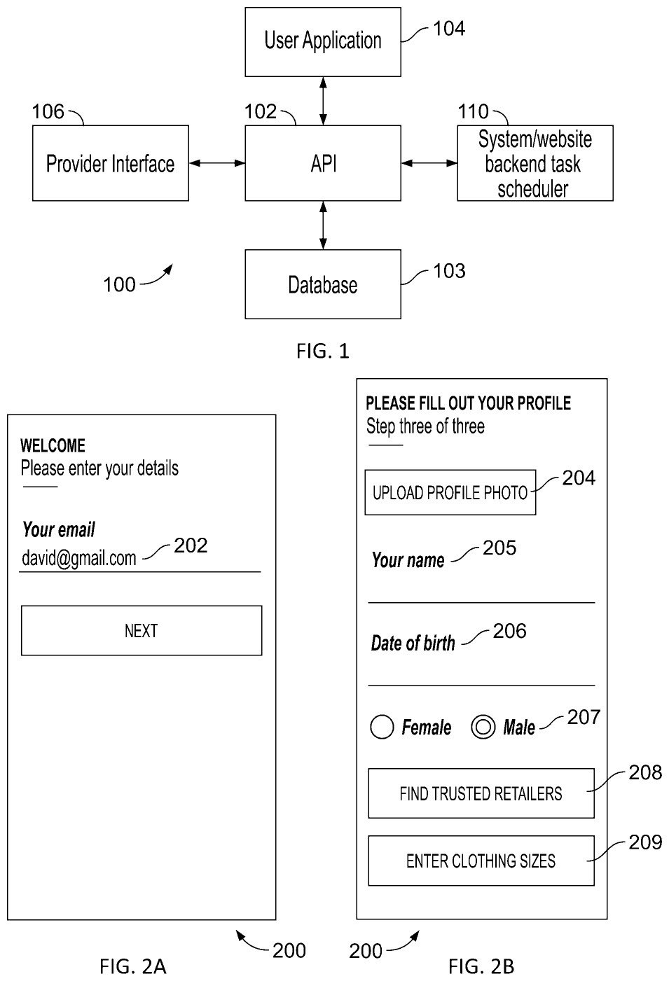

Referring to FIG. 1, this schematically illustrates the general system architecture that may be used in one possible embodiment of a proximity and intent centric personal data sharing system 100 in accordance with the present invention. The system 100 includes a API 102 associated with a database 103, a user application 104 and a provider interface 106. As illustrated, the system 100 also includes an optional system website and backend task scheduler (which together are designated 110 in FIG. 1).

The API 102 is the communication channel that provides data to the user application 104 and to the provider interface 106. The API 102 integrates and utilises a local database 103 for storing system related settings, preferences and data.

The user application 104 allows users to enter their personal details and preferences, to control which providers they trust to share data with, what data they wish to share, etc, as discussed further below.

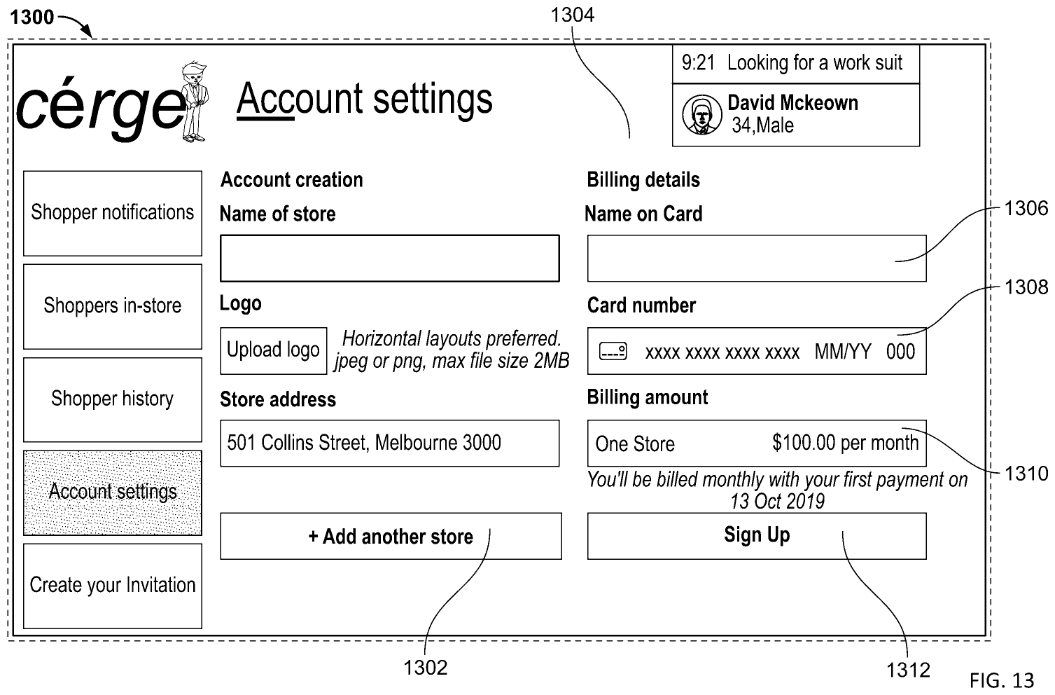

The provider interface 106 (also discussed further with reference to FIGS. 13-17) generally takes the form of an application (or a web-based dashboard or the like) operating on (or at least personnel at the provider can view the provider interface 106 and interact with it on) a device at the provider's location, such as e.g. a computer (e.g. a point of sale (POS) computer or terminal) or some other device or computer at the provider's premises, and which is linked to a website where providers can, for example (and using the provider interface 106), setup their profiles, enter and manage their provider locations (e.g. retail store locations), enter and manage any specific offers or incentives being offered, enter and manage their accessibility features, and enter and manage other such details and information which may be necessary or helpful to enable an individual (e.g. a customer) to share data with them, and which may also help to attract existing loyal customers, new customers, and/or customers with disability or other specific needs, and allow such customers to express their interest. The provider interface 106 receives and displays information on customers (e.g. shoppers) who are within the provider's premises (e.g. within their store) and also notifications of customers who intend to arrive within a defined time frame.

The system website 110 (if present) may allow administrators to manage the system configuration. The backend task scheduler (also designated 110 in FIG. 1) may facilitate scheduling of jobs, such as e.g. sending out group notifications, emails, etc, and may operate in the background.

### User Application

The user application 104 will typically be installed and used on a user device, such as e.g. a user's (customer's) mobile phone, tablet computer or the like. It is anticipated that the user application 104, upon being launched, will enter with a splash screen (now shown) showing a system logo before loading the necessary user application 104 assets. The user application 104 may also detect if the user application 104 does not currently have permission(s) to detect current location (e.g. based on the current location of the user's device) and, if necessary (i.e. if the user application 104 does not currently have location permission), prompt the user to turn on the required location permission(s) on the device. The user application 104 then calls the API 102 to obtain a list of user application configurations and a list of accepted providers and their provider locations (e.g. the name, address, geo location details, etc, of each such provider).

In order for a user to register or login, the user application 104 enters an email screen and calls the API 102. If a user profile has not yet been setup, one or more profile setup pages will next be shown. FIGS. 2A and 2B are examples of such user profile setup pages 200 of the user application 104. After confirmation of the user's email address 202 (i.e. after the user's email address 202 has been entered and possibly/optionally also confirmed via a confirmation email with an authorisation link or code or the like), the user is prompted to upload a photo to a photo URL link 204 and to also enter their name 205, date of birth 206 and sex 207. In the example in FIG. 2B, the user is then provided with the opportunity to “Find Trusted Retailers” 208 which takes the user to an “Invitation” screen, and to “Enter clothing sizes” 209 which takes the user to a profile screen.

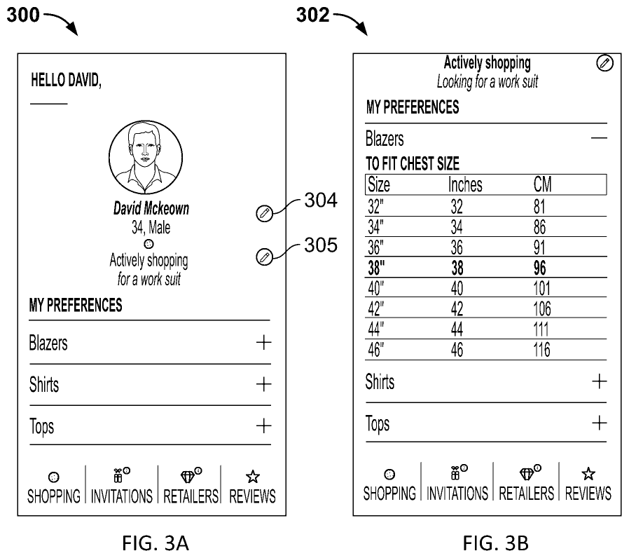

FIGS. 3A and 3B are examples of a profile screen 300 and a preference screen 302 respectively. The initial profile screen 300 displays a user photo (as entered at 204), name (as entered at 205), age (based on the date of birth entered at 206), sex (as entered at 207) and the user's current shopping status. An edit profile icon 304 takes the user to an “Edit Profile” screen (which is similar to the profile setup page in FIG. 2B), while an “Edit shopping status” icon 305 takes the user to a “Shopping Status” screen where the user can change their current shopping status, as discussed below.

As mentioned above, FIG. 3B illustrates a preferences screen 302. On loading the preferences screen 302, the API 102 is called to retrieve preference data. The API 102 returns preferences based on the user. As shown in the example in FIG. 3B, the data on the preference screen 302 may contain one or more categories (e.g. fashion), subcategories (e.g. blazers, shirts, tops etc.), and preference data (e.g. sizes). Although not shown in FIG. 3B, the preferences screen 302 may also include other user-configurable (i.e. user enterable) data such as the user's “must know” data (this may include data relating to a user's disability and/or specific needs and/or information that will assist service provider personnel to provide the user with the service(s) they require and/or in a way that is effective and desirable for the user). The preferences screen 302 may also include the user's “purpose” or “intent” data. This will generally be information about the user's intention in visiting the service provider's establishment (e.g. to purchase a business suit for work). The API 102 is called to save any user preference data entered by the user and the API 102 stores the results into database 103.

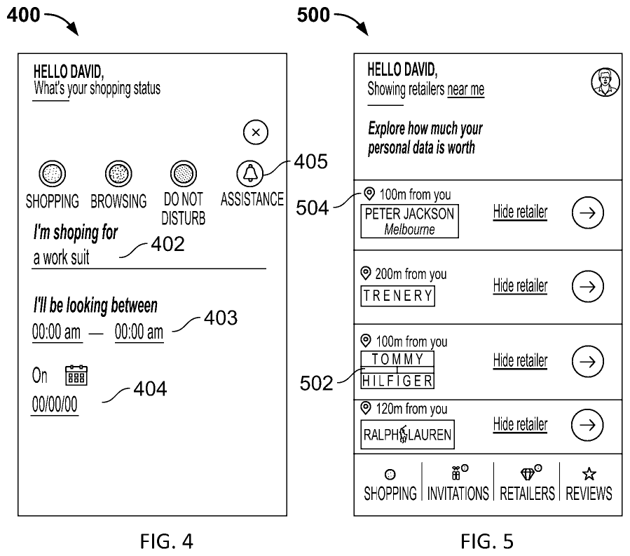

Turning to FIG. 4, this is an example of a shopping status screen 400. This screen includes (typically free text) data entry points for setting e.g. “Shopping For” 402 data (e.g. a work suit), and also for setting a shopping start time and end time 403 and shopping date 404. This screen also enables setting of current shopping status 405. In this example, setting the current shopping status 405 is done by selecting from the options: Shopping, Browsing, Do Not Disturb and Assistance. Once the settings and data entry points on the shopping status screen 400 are completed, the user application 104 calls the API 102 to save current shopping status. The API 102 then stores the shopper status into the database 103.

Referring to FIG. 5, this is an example of an invitations screen 500. On opening the invitations screen 500, the user application 104 calls the API 102 to return a list of new invitations based on the search/filter options input by the user. So, for example (and following on from the examples given in the previous Figures), FIG. 5 shows a number of new invitations from a number of fashion stores. These invitations are based on the data input by the user in FIG. 4, as discussed above. New invitations imply the invitation has never been accepted by user. For new invitations, the invitations screen 500 will typically provide provider logos 502 for each of the providers to which the new invitations relate and also the distance to each provider's nearest location 504. The user may choose to view a provider and invitation details which will take the user to an invitation detail screen for that provider, as discussed in more detail below. The user may choose to hide a provider and all future invitations, resulting in the user application 104 calling the API 102 to record a “hide provider” for the user. This results in the removal, for that user, of the invitation related to that provider and reloading of invitations.

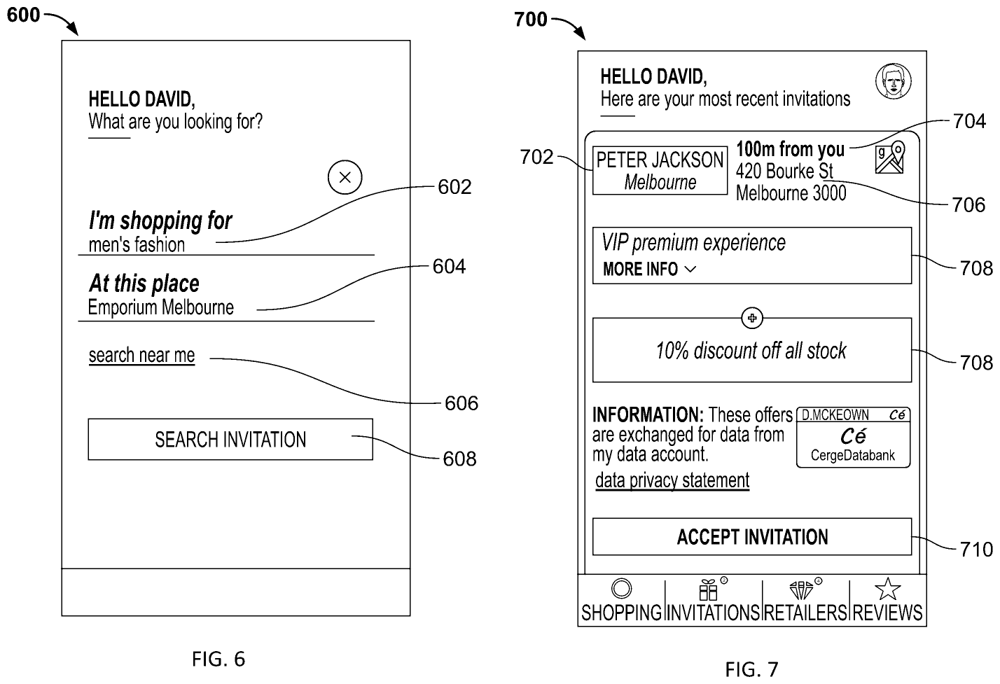

FIG. 6 is an example of a search/filter screen 600. This provides an interface for the user to indicate what they are “shopping for” 602, which is similar to the information entered on the shopping status screen 400. In this example, the search/filter screen 600 includes an entry for “At this place” 604, indicating the current location of the user. This may be an auto-complete text field. For example, this may list possible POIs (points of interest) based on the entered text using Google Place API. A “Search near me” option 606 is also provided which may return a list of POIs shown in a pop up for the user to select and populate in the “At this place” 604 field. A “Search Invitations” tab 608 takes the user back to the Invitation screen 500 and triggers a refresh of the invitation screen 500.

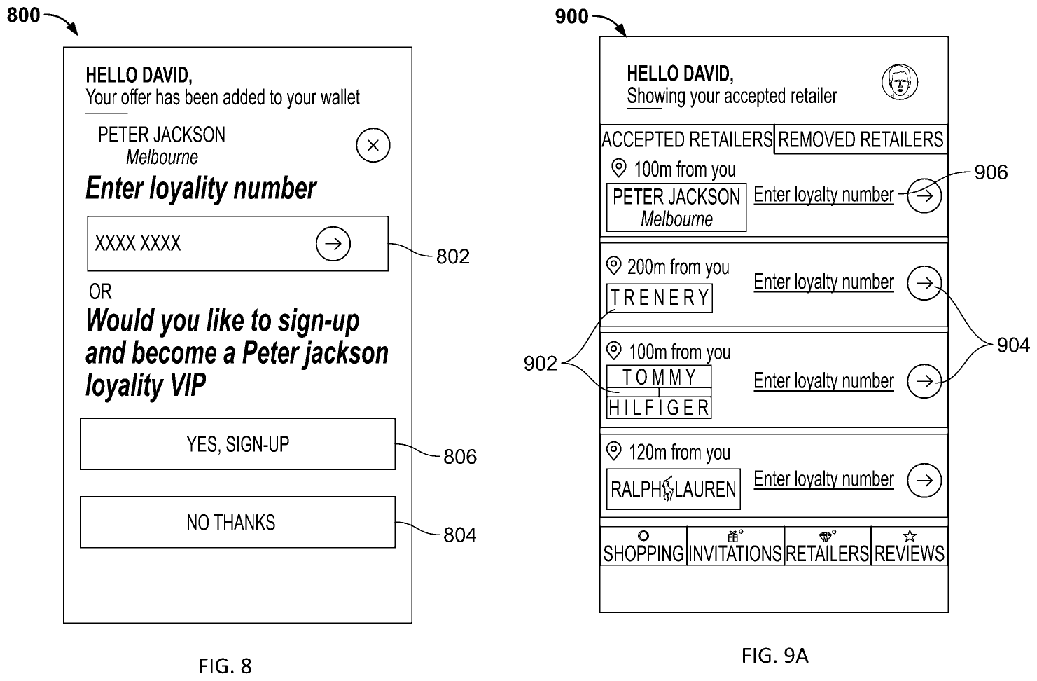

FIG. 7 illustrates an invitation detail screen 700. The invitation detail screen was mentioned above. This displays the provider logo 702 for a particular provider to which the invitation (i.e. the particular invitation which was clicked on by the user on the invitations screen 500) relates, and the provider's logo 702 on the invitation detail screen typically operates as a clickable link to the provider's website. The invitation detail screen also shows the distance 704 to the provider's closest location from the user's location and the address 706 of the provider's closest location. The invitation detail screen also displays offers 708. The number of offers 708 may be limited and set on the provider interface 106. The “Accept Invitation” tab 710 saves the provider against the user's preferences within the database 103. If the provider has a loyalty URL, then the user is redirected to a Loyalty screen (see FIG. 8). Otherwise, the user is redirected back to the invitations screen 500 and the accepted provider is removed from the list.

FIG. 8 is an example of a loyalty screen 800 of the user application 104. The user may enter their loyalty number at the “Enter Loyalty Number” tab 802. This saves the loyalty number against the user, then takes the user back to the invitations screen 500. The API 102 stores the loyalty number into the database 103. A “No Thanks” tab 804 takes the user back to the invitations screen 500. A “Yes, Sign-Up” tab 806 starts an in-app browser with the provider's loyalty URL. Once the provider's loyalty program signup procedure has been completed, the in-app browser is then closed and the user is returned to the invitations screen 500.

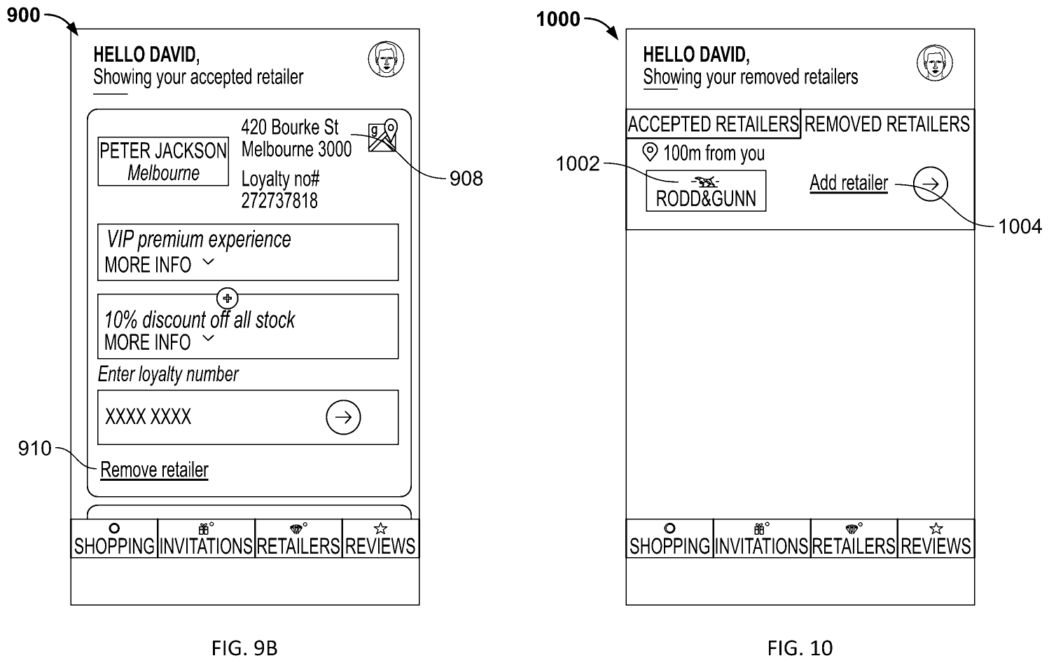

FIG. 9A is an example of an accepted providers screen 900 of the user application 104, and FIG. 9B is an example of a detail screen for a particular accepted provider. On accessing the Accepted Retailers tab in FIG. 9A, the user application 104 calls the API 102 to retrieve a list of accepted providers 902 and the user's loyalty number, if available. For each Accepted Retailer, the user may click on the “Next” icon 904 or a “Loyalty number” tab 906 to view an invitation detail screen (shown in FIG. 9B). When a provider is accepted by a user, the invitation detail screen will show loyalty number section 908 and a “remove retailer” link 910 which, if activated, calls the API 102 to record a hide provider for the user.

FIG. 10 illustrates a rejected providers screen 1000. On accessing this screen (by clicking on the “Removed Retailers” tab in FIG. 9A), the user application 104 calls the API 102 which retrieves a list of removed providers 1002 and displays them. The rejected providers screen 1000 also includes an “Add retailer” tab 1004 to let the user accept the rejected provider.

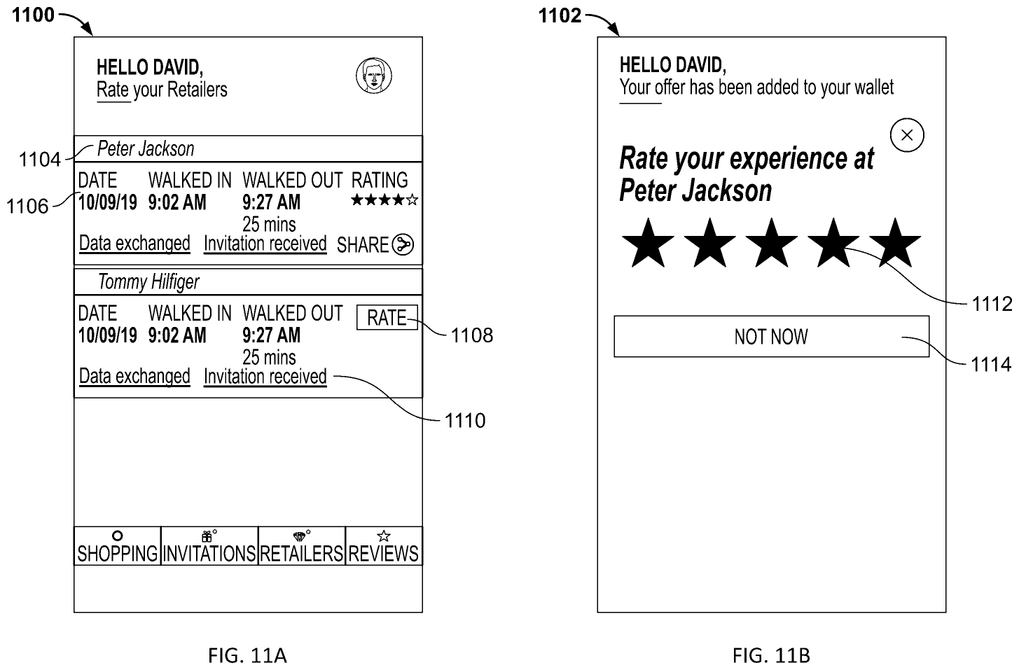

Referring to FIGS. 11A and 11B, these are a review screen 1100 and a rate provider screen 1102 respectively. The review screen 1100 lists providers 1104 and gives a history log 1106 of when the user visited each provider. On accessing this review screen 1100, the user application 104 calls the API 102 which retrieves historical data captured in the past. A “Rate” tab 1108 associated with the provider 1104 can be activated to take the user to the rate provider screen 1102. An “Invitation Received” tab 1110 takes the user to the invitations screen 500 of the user application 104.

The rate provider screen 1102 comprises 5 stars 1112 which the user can click on (i.e. the user can click on one, two, three, four or all five stars) to give the provider a rating. When the user gives the rating, the user application 104 calls the API 102 and the rating for the provider is recorded. The API 102 saves the rating in the database 103. If the user does not want to rate the provider, the user clicks on the “Not Now” tab 1114, which takes the user back to the review screen 1110.

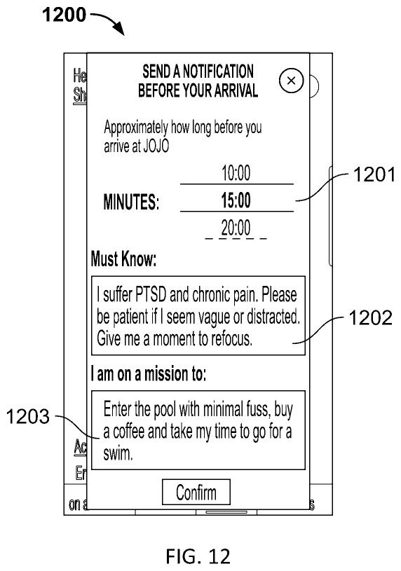

The notification screen 1200 shown in FIG. 12 can be used by a user to send a notification to a provider of their intention to visit the provider, prior to their arrival at the provider. The notification screen 1200 has an arrival time selection tool 1201 which a user can adjust (in this particular embodiment, this is done in 5 minute increments up to a maximum of 60 minutes prior to their intended arrival time). The notification screen 1200 also has a “Must Know” data entry field 1202 in which (similar to above) a user can enter (using free text) information that will assist service personnel at the provider to provide the user with the service(s) they require, and/or in a way that is effective and desirable for the user. For example, in the example in FIG. 12, the user has entered the following message to assist staff at the provider: “I suffer PTSD and chronic pain. Please be patient if I seem distracted. Give me a moment to refocus.” The notification screen 1200 also has a “purpose” or “intent” field 1203. In FIG. 12, the “purpose” or “intent” field is labelled “I am on a mission to:”. However, in other embodiments, this field 1203 may be labelled “My purpose today”, or something of this nature. In any case, the field 1203 enables the user to enter (using free text) information about the user's intention in visiting the provider's establishment. For example, in the example in FIG. 12, the user has entered a message in field 1203 to inform staff at the provider that the user's intention is to: “enter the pool with minimal fuss, buy a coffee and take my time to go for a swim”. The notification screen 1200 also has a “confirm” button 1204 which the user can press to send the entered estimated arrival time, “must know” and “purpose” information to the provider. When the user presses the confirm button 1204, the user application 104 calls the API 102 to store the information in the database 103 and send it to the Provider Interface 106. The provider interface 106 will be discussed further below.

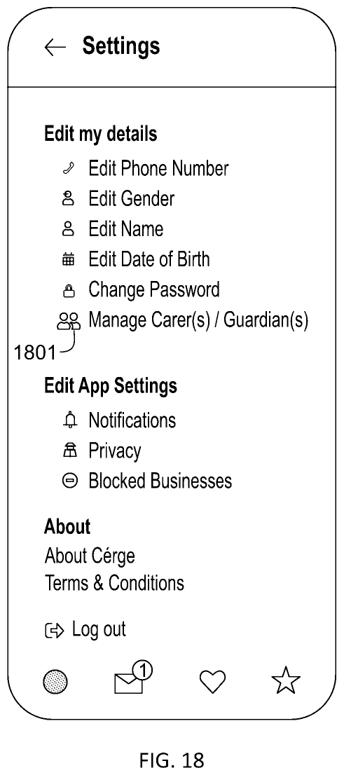

FIGS. 18-30 illustrate a further functionality that the user application 104 may (optionally) offer. This is a functionality whereby a user, such as e.g. a person who suffers from a relatively severe physical disability which impairs their ability to use (or prevents them from using) their own device or the user application 104 in certain situations (e.g. when out shopping or away from home etc), may authorise and enable e.g. a carer to operate and control the functions of the user application 104 on their behalf but using (i.e. from) the carer's own (separate) mobile phone or other mobile device. As part of this functionality whereby a user is able to authorise a carer to operate and control the functions of the user application 104 on their behalf, it is considered preferable that the user (on whose behalf the carer controls the application 104) should remain included in the communication (which is facilitated by the system) with e.g. retailers or other establishments about their needs, purpose, preferences and requests for interactions with staff at the establishment.

There is no limit to the number of carers that a user may have (i.e. there is no limit to the number of carers that a user may authorise to operate the functions of their user application 104 on their behalf).

It should be noted that the images in FIGS. 18-30 are screenshots of the user application 104, and although the screenshot in FIGS. 18-30 are slightly different in appearance to the images in FIGS. 2-12 (which are also screenshots of the user application 104), nevertheless FIGS. 18-30 still relate to the user application 104 in an embodiment having the same general functionality as that described with reference to FIGS. 2-12 above.

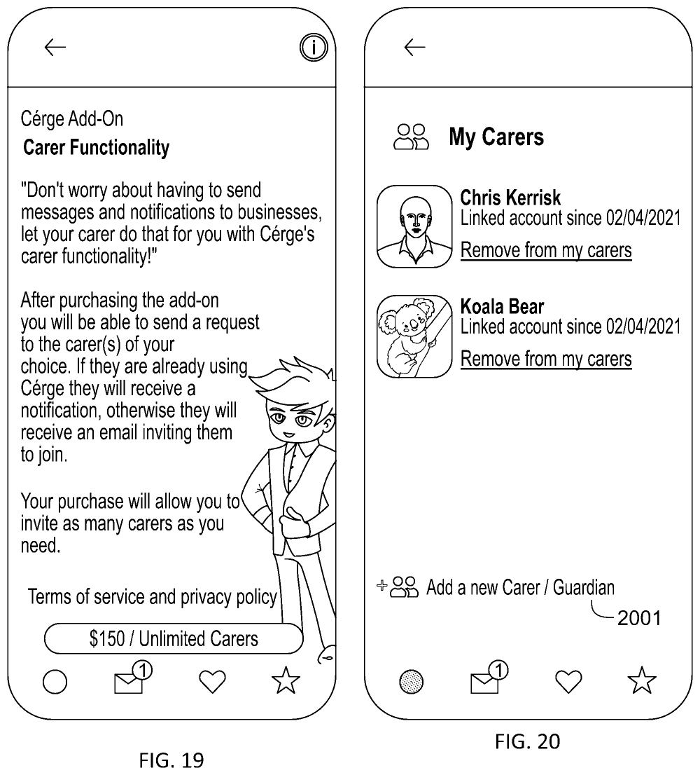

In order to authorise a carer, the dependent user who wishes to request the assistance of that person to act as a carer for them can click on the “Manage Carer(s)/Guardians” option 1801 shown in FIG. 18. The first time this is done, if payment is required to enable the carer functionality, this will bring up the screen in FIG. 19, which the user can use to provide the payment that may be required to enable the carer functionality. After any required payment has been provided to enable the carer functionality (if required), and thereafter whenever the user clicks on the “Manage Carer(s)/Guardians” option 1801, the screen shown in FIG. 20 will be displayed. Or, if no payment is required to enable the carer functionality, the screen in FIG. 20 may be displayed whenever (including the first time) the user clicks on the “Manage Carer(s)/Guardians” option 1801.

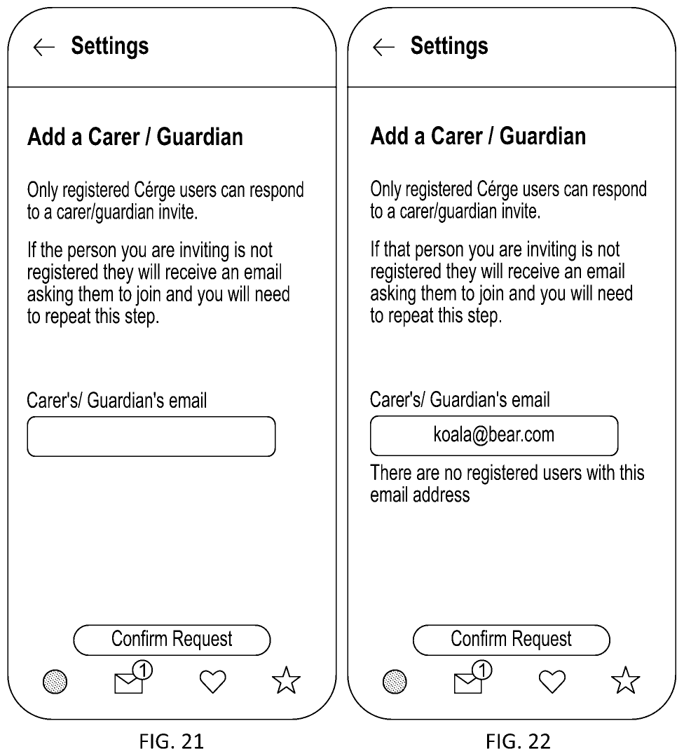

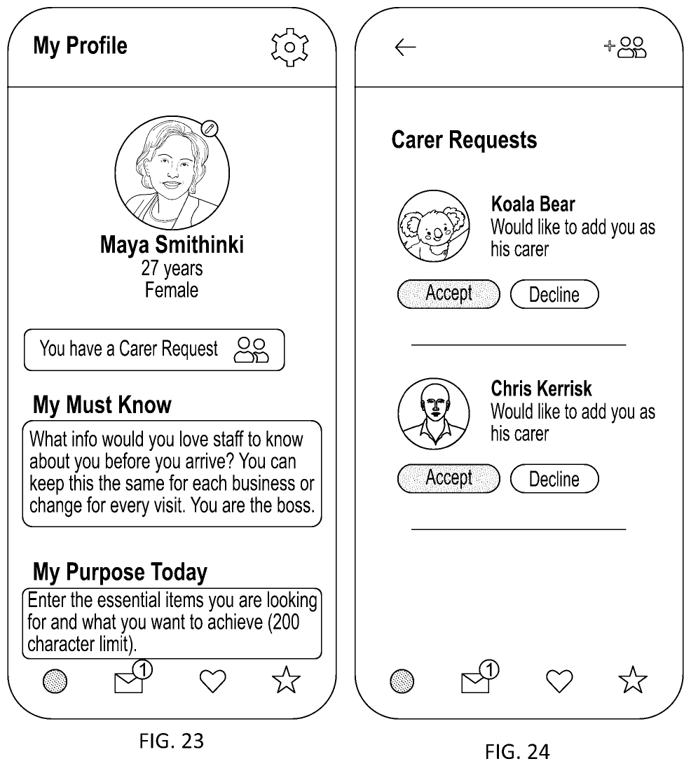

The screen in FIG. 20 lists the carers (if any) that the user has already added/authorised (i.e. those who can already control the user application 104 on the requesting/dependent user's behalf). If the requesting/dependent user has not added any cares, no carers will be shown on this screen. The requesting/dependent user can click on the “Add new Carer/Guardian” option 2001 to add a new carer (i.e. to begin preparing a request to send to another person to serve as a carer for them), which then causes the screen in FIG. 21 to be displayed. The requesting/dependent user can then enter the (proposed) new carer's email address on this screen, as shown in FIG. 22, and then click on the “Confirm Request” button. A carer request is then sent to the new (proposed) carer by email. Note: the (proposed) carer must also be a “user” of the system in the sense that they must also have the user application 104 installed on their own device. This is required in order for them to be able to operate the functions of the user application 104 on the requesting/dependent user's behalf (assuming they agree to become a carer for that requesting/dependent user). The fact that a new/pending carer request has been sent is shown on the requesting/dependent user's device, on the profile screen of the user application 104, as shown in FIG. 23. On the (proposed) new carer's device, any received carer requests will be displayed, and these can be either accepted or declined, as shown in FIG. 24.

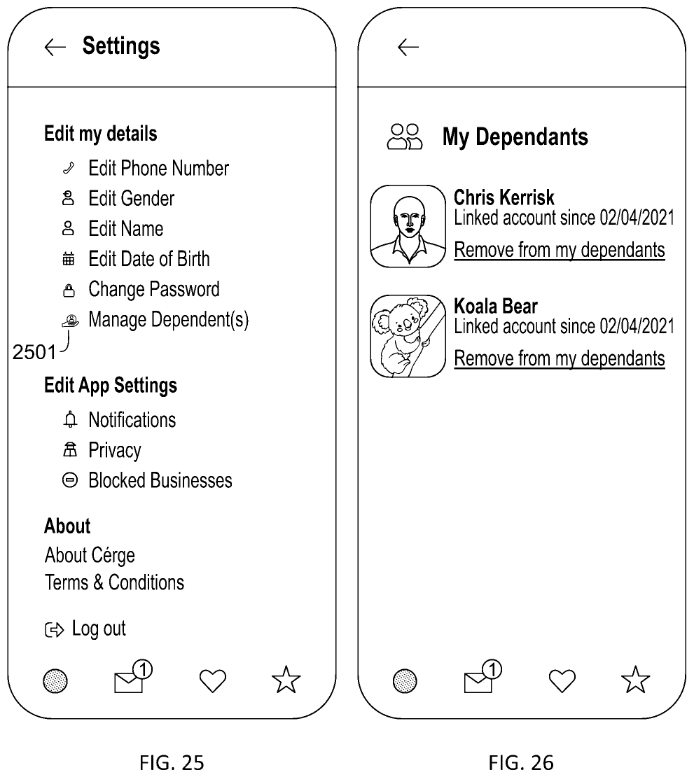

A person (user) who is appointed/added as a carer cannot also be a person (user) who is a dependent user. In other words, someone who has added another person to be a carer for them cannot also be a carer themselves for another person. Therefore, as soon as a person (a user) accepts an invitation to become a carer for another user, on their device the “Manage Carers/Guardians” option 1801 (shown in FIG. 18) changes to become a “Manage Dependents” option 2501, as shown in FIG. 25. A user who is a carer can also remove dependents, as shown in FIG. 26.

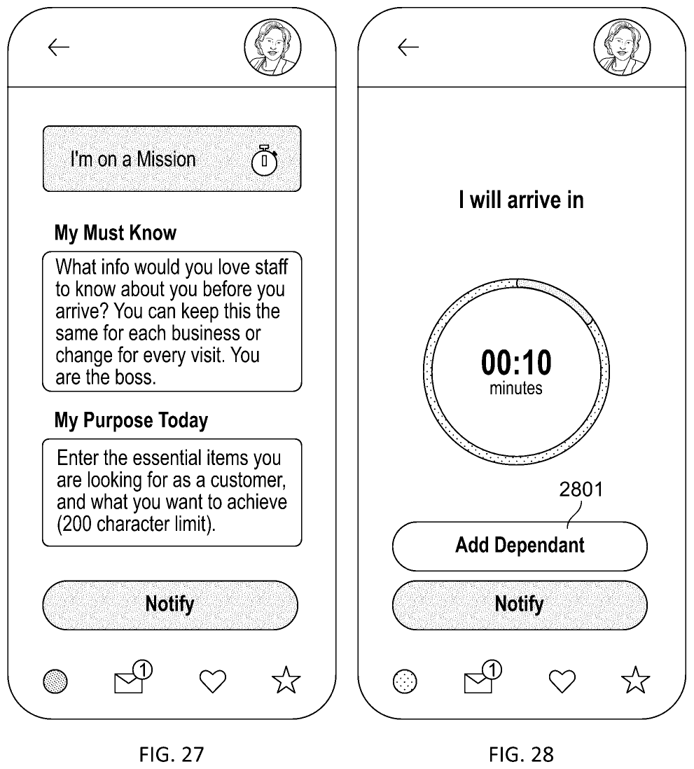

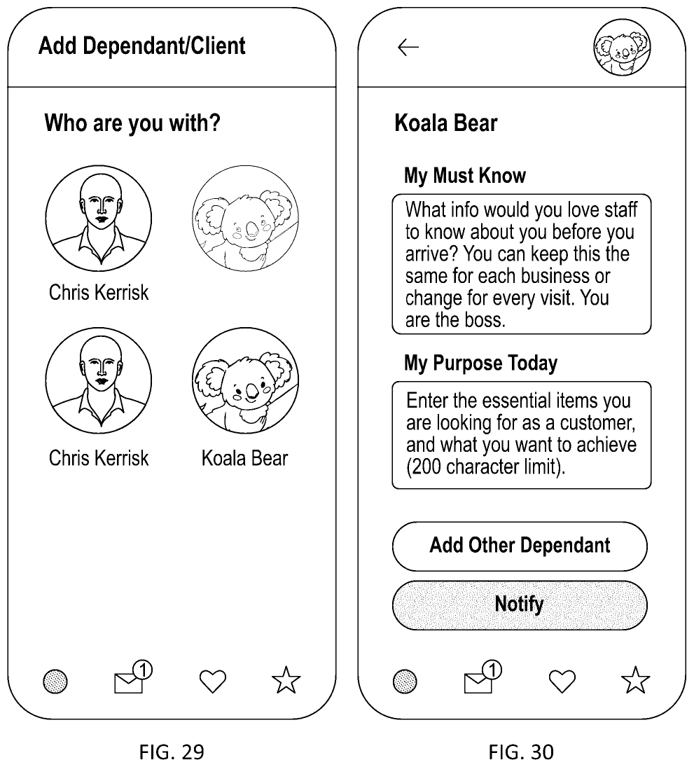

The way in which a carer can operate the functions of the user application 104 on behalf of a dependent user for whom they are an authorised carer is mostly the same as the way in which this is done by a user who is operating the user application 104 themselves (on their own behalf). Therefore, as shown in FIGS. 27 and 28, the carer can enter (into the user application 104 operating on the carer's own device) the carer's own “Must know” and “purpose” information, and also the intended arrival time. However, unlike the situation discussed above where a user is operating the user application 104 themselves (on their own behalf), when a carer is operating the user application 104 on behalf of a dependent user as well, after entering the time of arrival (as shown in FIG. 28) but before a notification is sent to the chosen establishment, the carer can click the “Add Dependent” option 2801. (This “Add Dependent” option only appears for carer users who have one or more dependents set-up.) If a user does not have any dependents set up, then the “Add Dependent” option does not appear (as the user in that case would not be a carer user). If a carer user selects to add a dependent at this step (e.g. by clicking “Add Dependent” 2801), they will next be taken to a screen which enables them to select which dependent user they are accompanying, as shown in FIG. 29. The carer user can then add the “Must know” and “purpose” information for that dependent user, as shown in FIG. 30. Then, if the carer user is accompanying more than one dependent user, they can do the same for each further dependent user by clicking “Add Other Dependent”, and repeating the same steps again.

Importantly, when a carer user sends a notification to an establishment on behalf of an individual who is (or on behalf of multiple individuals each of whom is) a dependent user, this activates or “wakes up” the user application 104 on the (or each) dependent user's device as well, whereupon that dependent user's device is also then (in addition to the carer user's device) actively checking location and attempting to “check in” once it is within a certain distance (e.g. 50 metres) of the establishment to which the notification was sent. As such, the carer user's device triggers the dependent user's device to become active too and to function as if the dependent user had triggered this themselves. Consequently, a carer user may set up and send a notification to an establishment on behalf of the (or each) dependent user, but the (or each) dependent user may then go into the establishment (and interact with service staff therein) by themselves. Thus, where the (or each) dependent user enters the establishment alone, it will often be the dependent user's device that will actively be attempting to (and ultimately will) check them in to the establishment upon arrival (and by this it is meant that when the system recognises that the dependent user is within the establishment, based on location data from the dependent user's device, the dependent user's device will send a notification of this to the provider which will cause an alert to sound and/or appear on the provider interface 106, thereby alerting staff at the provider to attend to the user as a newly arriving customer). Thus, where the (or each) dependent user enters the establishment alone, it will often be the dependent user's device that will actively attempt to (and ultimately will) check the dependent user in to the establishment upon arrival, even though that dependent user's device is not the one that was used to create the original notification sent to the establishment.

### Provider Interface

As mentioned above, the provider interface, which is designated 106 in FIG. 1, generally takes the form of an application (or a web-based dashboard or the like) operating on (or at least personnel at the provider can view it and interact with it on) a device at the provider's location, such as e.g. a computer (e.g. a point of sale (POS) computer or terminal) or some other device or computer at the provider's premises, which is linked to a website where providers can, for example, setup their profiles, enter and manage their provider locations (e.g. retail store locations), enter and manage any specific offers or incentives being offered, enter and manage their accessibility features, and enter and manage other such details and information which may be necessary or helpful to enable an individual (e.g. a customer) to share data with them, and which may also help to attract existing loyal customers, new customers, and/or customers with disability or other specific needs, and allow customers to express their interest.

The provider interface 106 receives and displays information on customers (e.g. shoppers) who are within the provider's premises (e.g. within their store) and also it also receives and displays notifications of customers who intend to arrive within a defined time frame.

It is anticipated that the provider interface 106, upon being launched, will enter with a splash screen showing the system logo followed by a “Sign up” option (which takes new providers to a sign up page) and a “Login” option (which takes providers who have previously signed up to a login page). The login/sign up page is provided with entry points for two parameters: username and password. The username must be an email address. When the sign up option is selected the provider interface 106 calls the API 102 to facilitate new provider registration. When the login option is selected the provider interface 106 calls the API 102 to validate login credentials and displays an error if the credentials are not valid. If successful, the provider details are returned by the API 102. If a provider token exists in local storage, the API 102 is called to validate the token. If the token is valid, the API 102 returns the provider profile and an updated user token. After successful login/registration the provider token is saved into the browser local storage. If payment options have not been setup, the provider is navigated to an “Account Settings” page, as illustrated in FIG. 13. If payment options have been setup, the provider is navigated to a “Shoppers in-store” page, as illustrated in FIG. 16.

FIG. 13 illustrates an example of an account settings page 1300. On accessing this page, the provider interface 106 calls the API 102 to retrieve the provider's account settings data. This data includes: provider (e.g. retailer) information, including name, logo and URL; and a list of locations, including (possibly for each location) the premises (e.g. shop) address, latitude, longitude and altitude, the premises (e.g. shop) mobile (or other) phone number, username/email address, and password. The account settings page 1300 is populated with the data returned from the API 102. The list of provider locations, such as stores, can be edited. For example, entries may be deleted from the list and a tab “+ Add another store” 1302 provides access to a pop up (form) with text fields for entry of the additional location (and associated information), which can then be saved to the provider's account. Entry of an additional location (i.e. store) provides a prompt to confirm with the provider that the additional location will incur costs of $x per month, which can be confirmed by the provider. When entering location data, the provider interface may use Google Place API to show potential addresses as the provider is typing the location address. A billing details section 1304 of the account settings page 1300 includes entry points for entering credit card details, including the card owner 1306 and the credit card number 1308. The provider interface 106 calls the API 102 to retrieve the cost per location and populates a “Billing amount” entry point 1310 with the number of locations and billing amount. A Stripe payment gateway is used for payments. Pressing a “Sign Up” tab 1312 results in the provider interface 106 calling the API 102 with a provider token, Stripe payment token, the number of stores and the cost per store.

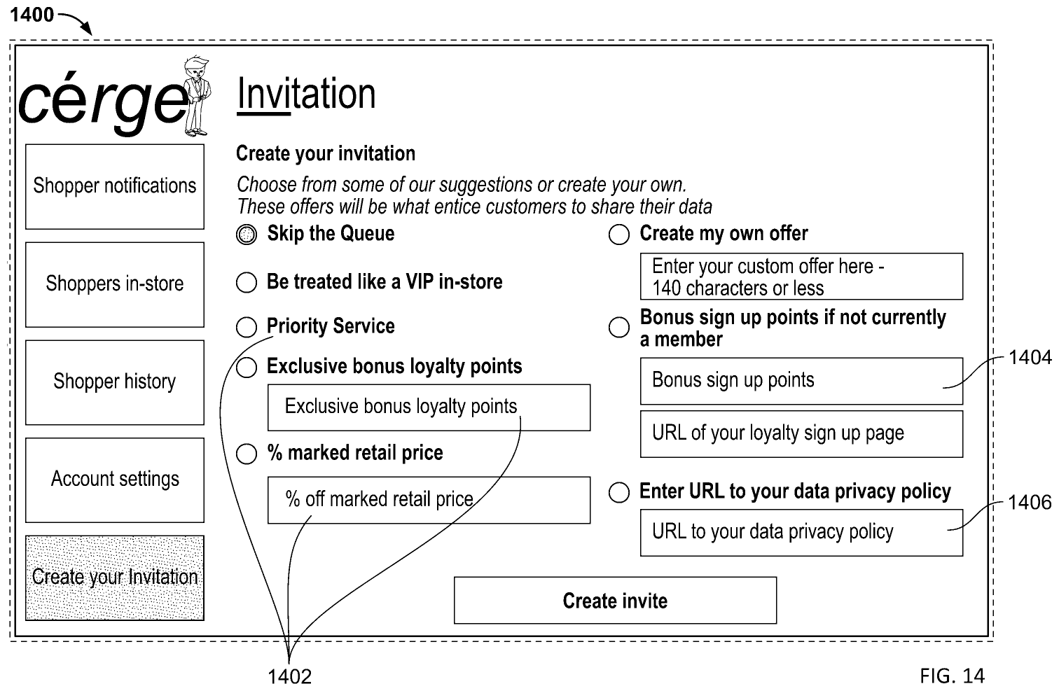

Turning to FIG. 14, a create invitation page 1400 is illustrated. On entering this page, the provider interface 106 calls the API 102 to retrieve a list of invitation options. The invitation options 1402 then populate the create invitation page 1400. The provider may be limited to choose between 1-3 invitation options 1402. Each provider can setup one set of invitation options for each location/store setup under the provider. A “Bonus signup points if not currently a member” text entry box 1404 and an “Enter URL to your data privacy policy” text entry box 1406 are hard coded to always display on the create invitation page 1400. Only provider users with admin access can make changes to this page, while other users from the provider can view this page, but cannot make any changes.

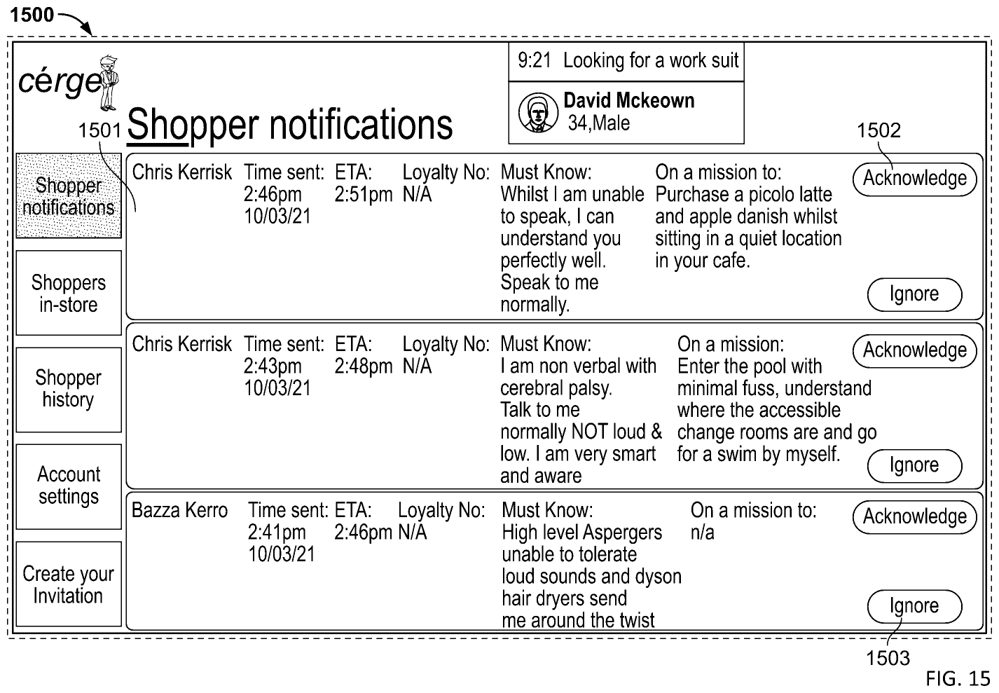

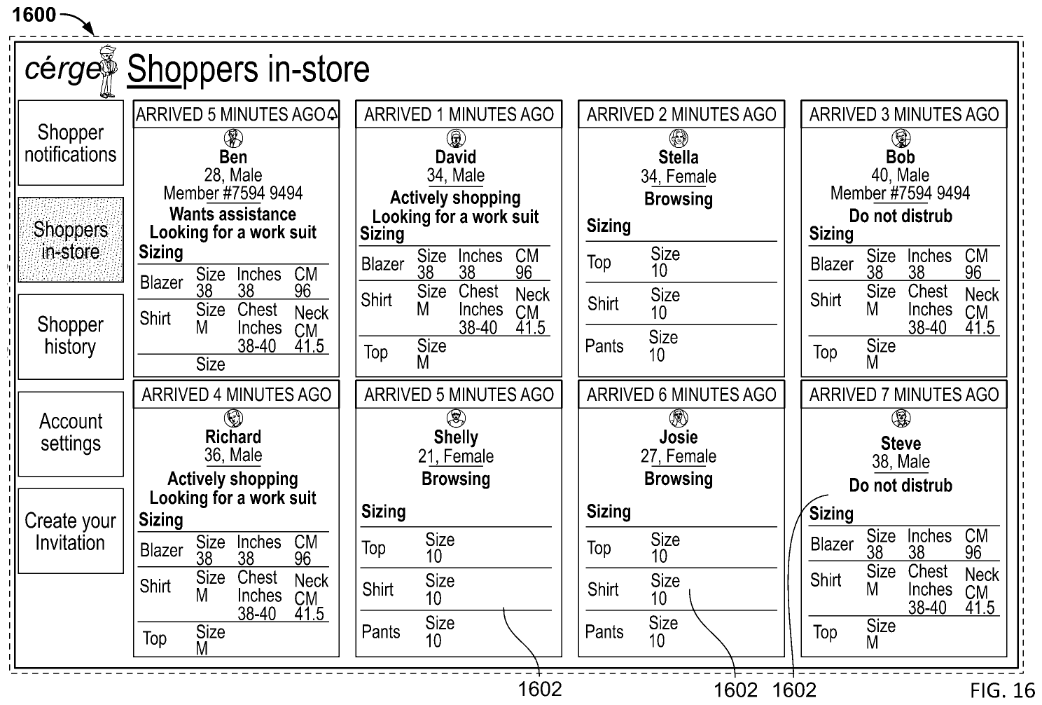

A shopper notification page 1500 is illustrated in FIG. 15. On accessing this page, the provider interface 106 calls the API 102 with a user token and provider location identifier. A list of shopper notifications are retrieved and the shopper notification page 1500 is populated with shopper notification details 1501. The provider interface comprises response options which may be provided to enable provider personnel (or possibly only those with administrator privileges) to respond to each notification received from a customer user. For example, in the example in FIG. 15, there is an Acknowledge response option 1502 and an Ignore response option 1503 for each user notification. If the Acknowledge response 1502 is entered in response to a user notification, this will call the API 102 and cause to be displayed to the user, on the user application 104 (on the device) of that user, that the provider has acknowledged the user notification. On the other hand, if the Ignore response option 1503 is entered in response to a user's notification, this operates effectively like the provider failing to answer a customer telephone call. Accordingly, the user is not alerted that their user notification has been “Ignored” (or denied, or anything like that) by staff at the provider. Rather, the user will simply not receive an indication that their notification has been Acknowledged by the provider, and this may in turn prompt the user to send another user notification, to which the provider may respond with an Acknowledge response 1502 (if they are able to attend to it), or with another “Ignore” response option 1503 (if the provider is still too busy or otherwise unable to attend to it).

A “shoppers in-store” page 1600 of the provider interface 106 is illustrated in FIG. 16. On accessing this page, the provider interface 106 calls the API 102 with a user token and provider location identifier. A list of shoppers that are currently “in-store” (i.e. within the provider premises) is retrieved and the “shoppers in-store” page 1600 is populated with their profiles 1602. The provider interface may have a drop-down list (which may be accessible or usable by all provider personal, or possibly only by those with administrator privileges) with a list of provider locations (e.g. retail shops) loaded in the provider's account and an “All” option made available. A provider location identifier may be used when calling the API 102.

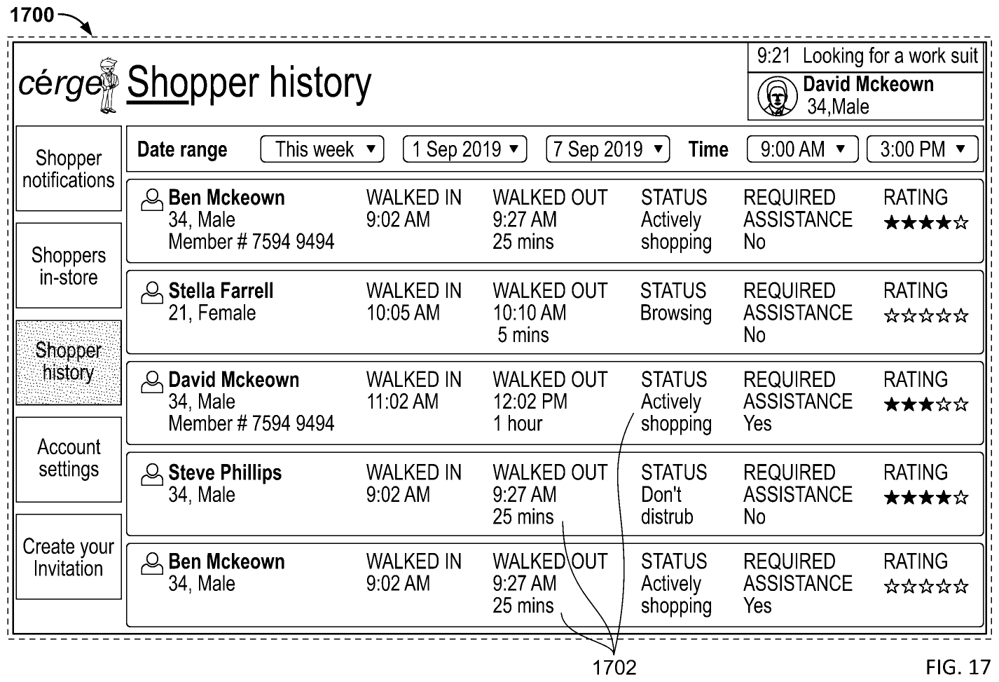

Referring to FIG. 17, this is an example of a shopper history page 1700. On accessing this page, the provider interface calls the API 102 to retrieve a list of shoppers' historical activities. The histories 1702 are loaded onto the shopper history page 1700. A drop-down list may be provided (which may be accessible or usable by all provider personal, or possibly only by those with administrator privileges) of provider locations (e.g. retail shops) loaded in the provider's account and an “All” option made available.

### Typical Interaction Example

An explanation will now be provided, by way of a simple example, of the way in which the user application 104 and the provider interface 106 can interact. In this example it is assumed that both the provider and the user (customer) are established users of the system and, in both cases, all necessary login, registration and other information has been entered, and that both the customer and the provider are logged on.

Typically, the first step will be for the user (customer) to enter their “Must know” information 1202, their “purpose” information 1203 (which is their intended reason for visiting the particular establishment) and their estimated time of arrival 1201. The way in which this is done is described above, including with reference to FIG. 12. It should be noted that, in some embodiments, the user application 104 may prevent the user (customer) (or a carer acting on their behalf) from sending a notification (i.e. a notification of the customer's intended arrival) to the provider interface 106 of an establishment if the customer is less than a certain predetermined distance from the establishment. Thus, for example, if a customer user (or a carer acting on their behalf) is already less than, say, 100 m (or some other predetermined distance) from the establishment which the customer user wishes to visit, the system may prevent the user (or the user's carer) from sending a notification to the provider interface 106 of that establishment. Of course, the user (or their carer) could still send notifications to other establishments that are more than the predetermined distance away.

Shortly after the customer user (or a carer acting on their behalf) sends a notification (of intended arrival) to the establishment which the customer user wishes to visit, a notification will appear on the provider interface 106 at that establishment. Typically the notification that appears on the provider interface 106 at the establishment will be (or it will include) some form of visible message or alert that can be seen by staff on the screen of the device at the establishment, and/or it may include an audible alert that can be heard by personnel at the provider establishment. This visible and/or audible alert may be persistent, for example, it may “pop-up” on the screen and/or “sound” repeatedly for a certain period of time (e.g. it might “pop-up” and/or “sound” repeatedly, say, 2 to 10 times over a period of, say, 2 and 5 minutes) until the notification is either “Acknowledged” (see 1502 in FIG. 15) or Ignored (see 1503 in FIG. 15).

As shown in FIG. 15, it will generally be the case that the name, expected time of arrival, loyalty number (if applicable), “must know” and “purpose” information for each customer user from (or for) whom a notification has been received is visible to staff at the establishment. This information can therefore be reviewed/considered before a decision is made by the staff at the establishment to either “Acknowledge” or “Ignore” a particular user notification.

If staff at the establishment “Acknowledge” the notification from a customer user (e.g. by clicking Acknowledge 1502), then a notification will be sent back to the user application 104 (operating on the device) of that user to confirm that their notification (of intended arrival) has been received and acknowledged. This provides comfort and peace of mind to the customer user because they can be confident (or at least more confident that they could be otherwise) that their particular desires and needs will be recognised, respected and accommodated upon arrival and during their interaction at the establishment.

On the other hand, if staff at the establishment “Ignore” the notification from a customer user (e.g. by clicking Ignore 1503), then as explained above, this operates effectively like failing to answer a customer telephone call. Accordingly, the customer user is not alerted that their notification (of intended arrival) has been “Ignored” (or denied, or anything like that). Rather, the customer user simply will not receive an indication that their notification has been received and acknowledged, and this may in turn prompt them (or their carer) to send another notification to the establishment, to which staff at the establishment may then respond with an Acknowledge response 1502 (if they are able to attend to it), or with another “Ignore” response 1503 (if they are still too busy or otherwise unable to attend to it).

When a customer user arrives at the establishment (or once they are within the above-mentioned predetermined distance, e.g. 100 m), they are able to “check-in” to the establishment. The user application 104 may be configured to perform this “check-in” automatically once the user's device detects (using location data) that the user is within (or within the predetermined distance of) the establishment. Alternatively, the user application 104 can be configured such that this “check-in” must be performed manually on the user application 104 by the user upon arrival.

Once a customer user has “checked-in” to the establishment (regardless of whether this is done automatically by the user application 104, or by the user manually “checking in” via the user application 104 upon arrival) another notification will appear on the provider interface 106 at the establishment. This notification will again be (or it will include) some form of visible message or alert that can be seen by staff on the screen of the device at the establishment, and/or it may include an audible alert that can be heard by staff at the establishment. This visible and/or audible alert may again be persistent, for example, it may “pop-up” on the screen and/or “sound” repeatedly until the staff at the establishment navigate to the profile of the customer within the list of shoppers that are currently “in-store” (which is provided on the “shoppers in-store” page 1600—see FIG. 16 above). Although not shown in the Figures, clicking on the profile for a particular customer who has “checked-in” will present an option to enable the establishment staff to “acknowledge” that that particular customer user has “checked-in” (i.e. that they have arrived). Thereafter, the staff at the establishment can attend to a customer's needs, and through the operation of the system (as has now been described), the staff at the establishment can attend to the customer's needs armed with the information (including e.g. the “must know”, “purpose” and any other information) that the user has provided thereby helping to remove the fear and anxiety often experienced by customers with disability before and during a customer service experience, and/or enabling the staff at the establishment to provide the customer with the service(s) they require and/or in a way that is effective and desirable for the customer.

In this specification, the term “comprising” is (and likewise variants of the term such as “comprise” or “comprises” are) intended to denote the inclusion of a stated integer or integers, but not necessarily the exclusion of any other integer, depending on the context in which the term is used.

Unless the context requires otherwise or specifically stated to the contrary, integers, steps or elements of the invention recited herein as singular integers, steps or elements clearly encompass both singular and plural forms of the recited integers, steps or elements.

It is to be understood that the present invention is not limited to specific features shown or described since the means herein described comprise preferred forms of putting the invention into effect. The invention is, therefore, claimed in any of its forms or modifications within the proper scope of the appended claims appropriately interpreted by those skilled in the art.

What is claimed is:

1-27. (canceled)

28. A personal data sharing system comprising:
an application program interface (API) that interacts with a database storing system settings and system data;
a user application associated with a user device for entry of user data and transfer of the user data to and from the API; and
a provider interface associated with a provider device for entry of provider data and transfer of the provider data to and from the API,
wherein a user of the personal data sharing system can, via the user application, notify a provider of an intent to arrive at a location of that provider, and when the user arrives at, or is within a predetermined distance of, the provider location, an alert is provided to personnel at the provider location via the provider interface.

29. The personal data sharing system as claimed in claim 28, wherein to notify the provider of the user's intent to arrive at the provider location, the user can, via the user application, send a user intention notification which is received via the provider interface.

30. The personal data sharing system as claimed in claim 29, wherein the user intention notification contains information which the user has previously entered via the user application and which personnel at the provider location may use to help provide the user with service(s) sought by the user and/or in a way that is effective and desirable for the user.

31. The personal data sharing system as claimed in claim 29, wherein when a user intention notification is received via the provider interface of a provider, but before the user arrives at, or is within a predetermined distance of, the relevant provider location, the provider interface produces a visible and/or audible alert to inform personnel at the relevant provider location of the user's intended arrival.

32. The personal data sharing system as claimed in claim 31, wherein the information which the user entered via the user application includes the user's estimated time of arrival at the provider location, and optionally also other information including “must know” information and/or “purpose” information.

33. The personal data sharing system as claimed in claim 31, wherein personnel at the provider location can, via the provider interface, select to either acknowledge or ignore a user intention notification, and
if personnel at the provider location select, via the provider interface, to acknowledge the user intention notification, an acknowledgement notification is returned and received via the user application, and
if personnel at the provider location select, via the provider interface, to ignore the user intention notification, no notification is returned.

34. The personal data sharing system as claimed in claim 28, wherein, when a user arrives at, or is within the predetermined distance of, a provider location which the user intends to visit, the user can, via the user application, “check-in” to that provider location.

35. The personal data sharing system as claimed in claim 34, wherein the user application can be configured to perform “check-in” automatically when the user arrives at, or is within the predetermined distance of, the relevant provider location.

36. The personal data sharing system as claimed in claim 34, wherein when a user, via the user application, “checks-in” to the relevant provider location, an arrival alert is generated by the provider interface.

37. The personal data sharing system as claimed in claim 36, wherein, when an arrival alert is generated by the provider interface, information including “must know” information and/or “purpose” information is made available to personnel at the provider location via the provider interface.

38. The personal data sharing system as claimed in claim 28, wherein a user can, via the user application, (i) enter and/or manage and/or control and/or change information that is shared with providers, and/or (ii) control and/or manage and/or change which providers any of their information can be shared with.

39. The personal data sharing system as claimed in claim 28, wherein the user application can receive invitations from one or more providers, and the user is able to, via the user application, select an invitation from a particular provider to obtain information about that provider.

40. The personal data sharing system as claimed in claim 39, wherein the invitations received by the user application for a particular user are determined based on information that the user has entered via the user application.

41. The personal data sharing system as claimed in claim 40, wherein the information about a provider that the user can obtain by selecting the invitation from that provider includes the distance to the provider's closest location and the address of that closest provider location.

42. The personal data sharing system as claimed in claim 28, wherein the provider interface can be used to enable a provider to do any one or more of the following: setup their system profile(s), enter and/or manage their provider location(s), enter and/or manage any specific offers or incentives being offered, enter and/or manage their accessibility features, enter and/or manage details and information which may be necessary or helpful to enable a user to share data with them and/or which may help to attract existing user customers, new user customers and/or user customers with disability or other specific needs, and/or allow such user customers to express their interest.

43. The personal data sharing system as claimed in claim 28, wherein a first user of the system can, via the user application on the device of that user, authorise and enable a second user to control and operate functions of the user application on behalf of the first user.

44. The personal data sharing system as claimed in claim 43, wherein a second user who is authorised and enabled to control and operate functions of the user application on behalf of a first user can control and operate the functions of the user application on behalf of that first user using the second user's device.

45. The personal data sharing system as claimed in claim 44 wherein, where a second user is authorised and enabled to control and operate functions of the user application on behalf of a first user, notifications and information that would appear on a user's device as a result of information entered, or notifications sent, by that user, will also appear on the device of the first user even though information may have been entered, or notifications sent, on behalf of the first user by the second user and using the second user's device.

46. The personal data sharing system as claimed in claim 44 wherein, where a second user is authorised and enabled to control and operate functions of the user application on behalf of a first user, to notify a provider of the first user's intent to arrive at a provider location of that provider, the second user can, via the user application on the second user's device, send a user intention notification to the provider on behalf of the first user which is received via the provider interface, and once the user intention notification has been sent, the user application on the first user's device is activated and begins to attempt to automatically check-in at the provider location such that if the first user arrives at, or comes within the predetermined distance of, the relevant provider location alone or without the second user, the first user's device will perform “check-in” automatically and an arrival alert will be generated by the provider interface.

47. The personal data sharing system as claimed in claim 43, wherein a second user who is authorised and enabled to control and operate functions of the user application on behalf of a first user cannot authorise and enable another user to control the user application on their behalf.
